(19) United States
(12) Patent Application Publication
(10) Pub. No.: US 2025/0299046 A1
(43) Pub. Date: Sep. 25, 2025

(54) Statistically Comparable Artificial Neural Network Benchmarks

(71) Applicant: Alain Hadges, Harrisburg, PA (US)

(72) Inventor: Alain Hadges, Harrisburg, PA (US)

(21) Appl. No.: 18/610,264

(22) Filed: Mar. 20, 2024

(51) Int. Cl. G06N 3/0895

(52) U.S. Cl. CPC G06N 3/0895

(57) ABSTRACT

An essay for benchmarking and comparing the reasonably expected performance of an artificial neural network using different hyper-parameter settings for the same or different training datasets, and different artificial neural networks using different hyper-parameter settings with the same training dataset. The prior art presumes that artificial neural network performance metrics have the same statistical distributions at different hyper-parameter settings, and is further subject to decisions that researchers can make between multiple ways of collecting and analyzing data that can influence benchmark results. This essay uses an objectively determined over-training epoch as the benchmark metric measurement point, a factorial experiment framework and structured randomization to estimate hyper-parameter effects and interactions on benchmark metrics, estimate hyper-parameter optimization complexity, and to test the normality of benchmark metric distributions at different hyper-parameter settings. Bayesian highest posterior density intervals are used as benchmarks along with a concise display of the essay results.

### TECHNICAL FIELD AND APPLICABILITY OF THE INVENTION

This invention relates to the process of establishing statistically comparable performance benchmarks for artificial neural networks.

### BACKGROUND OF THE INVENTION

This invention is a new process created from separate and independent existing statistical methods and artificial neural network training processes. For the purpose of clarity, the following definitions are used and their best modes identified:

Artificial Neural Network: A computational learning system that operates in a manner inspired by the natural neural network in the brain. A distinguishing feature of artificial neural networks is that knowledge of its domain is distributed throughout the network itself rather than being explicitly written into the program. This knowledge is modeled as the connections between the processing elements (artificial neurons) and the adaptive weights of each of these connections.

Bayesian Highest Posterior Density Interval: An established independent statistical methodology that is the Bayesian analog to confidence intervals in frequentist statistics. It is the narrowest interval, or intervals if discontinuous, containing the specified mass. Described in IDS non-patent literature reference #1 (2013, A. Gelman, J. B. Carlin, H. S. Stern, D. B. Dunson, A. Vehtari, D. B. Rubin). Absent specific artificial neural network performance knowledge, the best mode is to use a 95% mass.

Benchmark: A measure of a benchmark metric(s) of an artificial neural network used for comparisons to other benchmarks.

Benchmark metric: A training performance metric that is used as part of a benchmark to compare the performance of artificial neural network designs. The number of benchmark metrics (B) may vary between artificial neural network designs. A basic set of benchmarks are the over-training epoch in the form of the minimum validation loss epoch and validation accuracy (B=2). An artificial neural network that is designed to select multiple objects from a single image may additionally have the number of objects correctly detected as a benchmark metric (B=3), or even stratified as the number of correctly identified objects in images with 1, 2, or 3 objects (B=5).

Data-Loading: The process of reading the training data during the training process.

Data-Loading Sequence: The sequence in which the training data are loaded during the training process. This can affect the training accuracy. The data-loading Sequence may also be a hyper-parameter if its effects are being benchmarked.

Data-Shuffling: The process of reading the training data in a random sequence during training. It is an option that can be set in virtually all artificial neural network computing environments. Data-shuffling may also be a hyper-parameter if its effects are being benchmarked.

Epoch: An epoch is one training-pass through the entire training dataset.

Factorial Experiment: An established and independent statistical methodology for simultaneously determining the effects and interactions of multiple variables, per IDS non-patent Literature Reference #2 (1978, G. E. Box, W. H. Hunter, S. Hunter).

Fixed Artificial Neural Network: An artificial neural network that does not change its hyper-parameters, architecture or operation during training. This also excludes artificial neural networks that are comprised of multiple artificial neural networks that switch the processing to other artificial neural networks during training.

Graph: a diagram (such as a series of one or more points, lines, line segments, curves, or areas) that represents the variation of a variable in comparison with that of one or more other variables.

Graph Orientation: The direction in which the arrangement of data in a graph is made or described. A graph is described by the alignment of data to a particular axis such as the vertical or horizontal axes. A graph's axes can be transposed without changing the relationship of the data it represents.

Graph Categorical Axis Sort-Order: The data of graphs with categorical axes can be sorted to show a variable of interest's relationship to the categories of the axes, such as from low-to-high category mean value. The sort-order along categorical axes using the same variable values can be changed without altering the relationships the graph represents.

Hyper-Parameter: An artificial neural network variable setting that can affect the performance of the artificial neural network.

Hyper-Parameter Level Setting: The setting designation of the factorial experiment for the hyper-parameter. The best modes are low(−), high(+) and mid-point(0).

Hyper-Parameter Level Setting Value: The value of a hyper-parameter at a particular factorial experiment level designation.

Hyper-Parameter Level Setting Spread: The range between the high(+) and low(−) hyper-parameter level settings value to be used in the factorial experiment design. The best mode is the largest range that results in an observable difference in artificial neural network performance without causing training instability.

Hyper-Parameter Optimization: The selection process of identifying hyper-parameter settings to obtain the desired performance of the artificial neural network.

Kernel Density Estimation: An established and independent statistical method that that applies kernel smoothing for probability density estimation, described in IDS non-patent literature reference #3 (1991, Sheather, S. J., & Jones, M. C.).

Minimum Validation Loss Epoch: The epoch at which the validation loss ceases to decrease can be the over-training epoch. Generally, the smaller the number of epochs to reach the minimum validation loss, the more efficient the artificial neural network design is. During training the validation loss may oscillate while on a decreasing or increasing trend. The degree of oscillation varies for different artificial neural networks. Absent specific performance knowledge of a particular artificial neural network design, the best mode for objective identification of the minimum validation loss epoch is the first epoch followed by ten-subsequent epochs with no lower validation loss as this does not prematurely cut-off training in the case of oscillatory behavior. An example of specific performance knowledge of an artificial neural network design would be knowledge that its validation accuracy does not oscillate in training, but continually decreases until a particular epoch, and from then on continually increases.

Objective Determination of the Over-Training Epoch: An objective methodology to determine the over-training epoch for each essay training-run is required. As an example: objectively determination of the minimum validation loss epoch is an objective determination of the over-training epoch that can be used for each training-run in an essay. Other metrics that objectively identify the epoch at which over-training may occur can be used.

Optimizer: An artificial neural network component that determines the computational method used to obtain the best result during training.

Over-Training: Over-training starts when the artificial neural network begins to memorize the training data as opposed to just the features that make it useful for more than just the training data.

Over-Training Epoch: The epoch at which over-training may begin.

ResearcherDegrees of Freedom: The decisions that researchers can make between multiple ways of collecting and analyzing data that can influence the results. Described in IDS non-patent literature reference #4 (2016, J. M. Wicherts, C. L. Veldkamp, H. E. Augusteijn, M. Bakker, R. Van Aert, and M. A. Van Assen).

Table: A systematic arrangement of data usually in rows and columns for ready reference.

Table Orientation: The direction in which the arrangement of data in a table is made or described. A vertically oriented table is described by column placement. A horizontally oriented table is described by row placement. A vertically oriented table can have it's columns and rows transposed and become a horizontally oriented table without changing the relationship of the data it contains, and vice-versa.

Training: The machine learning process used to obtain knowledge from training data and put it into an artificial neural network.

Training Data: Data that is used to train an artificial neural network.

Training Dataset: The combination of training data and validation data used to train an artificial neural network.

Training Instability: The failure of the training run to reach its highest accuracy can occur for many reasons comprising exploding gradients, vanishing gradients, hyper-parameter settings that are too large and keep over-shooting and under-shooting a maximum or minimum gradient. Some empirical testing may be required to identify the hyper-parameter setting values that do not cause instability.

Training Run: The process of training an artificial neural network that involves multiple passes through a training dataset (epochs), each time refining the values of the artificial neural network's adaptive weights.

Training Performance Metric: The metric(s) that characterize the training performance of an artificial neural network, some or all of which may become benchmarks for comparisons. The design and purpose of an artificial neural network will determine the number of training performance metrics. A basic single object image detection artificial neural network can have two training performance metrics: the over-training epoch and validation accuracy, in which the over-training epoch is the minimum validation loss epoch. An artificial neural network that is designed to identify multiple objects in images may have at least one more performance metric in the form of the number of images correctly identified in a single picture.

Validation: A comparison of the knowledge that an artificial neural network has obtained from training to the validation data. This comparison is used to guide the training process.

Validation Accuracy: A computation of the correct classifications of the validation data at a particular epoch based upon the artificial neural network's training at that epoch. Validation accuracy is an indicator of the inference capability of the artificial neural network on data on which it was not trained.

Validation Data: Data that were not used to train an artificial neural network. Validation data are often a subset of the training data that is withheld from the training process, but may also be different data altogether.

Validation Loss: A computation of the incorrect classifications of the validation data at a particular epoch based upon the artificial neural network's training achievement at that epoch.

Variable Artificial Neural Network: An artificial neural network that changes its hyper-parameters, architecture or operation during training. This includes artificial neural networks that are comprised of multiple artificial neural networks that switch the processing to other artificial neural networks during training.

### BRIEF SUMMARY OF THE INVENTION

### A. Technical Problem

The prior art consists of various metrics used to compare the performance of artificial neural networks. The median of 5-runs was used for comparisons in as shown in the non-patent literature references listed in the IDS non-patent literature reference #5 (2016, S. Zagoruyko). The Top-1 and Top-5 accuracy rates were used, shown in IDS non-patent literature reference #6 (2016, K. He). Even the root mean square (RMS), shown in IDS non-patent literature reference #7 (2015, A. Karpathy). These metrics imply that there is a distribution of benchmark metrics, but they lack an assertion of statistical validity for comparisons, or any measure of benchmark metric distributions. The prior art can only make statistically valid comparisons of benchmark metrics of different artificial neural network by happenstance. This is because of three reasons:

First, prior art benchmarks such as those in paragraph implicitly presume that distributions of the performance metrics are normal and/or the same at different hyper-parameter settings. However, comparisons of small samples from different distributions can be statistically unreliable.

Second, prior art benchmarks such as those in paragraph [0041] have researcher degrees of freedom problems as described in paragraph [0027]. FIG. 1 shows an example graph of the validation accuracy and the validation loss for each epoch during the training of an artificial neural network. The expected function of training an artificial neural network is for the validation loss to decrease as the validation accuracy increases with each epoch. Over-training may begin to occur when the validation loss ceases to decrease. In the prior art, as shown in FIG. 1, the researcher has the discretion to select how many training epochs will be run in a benchmark and at which epoch the validation accuracy will be measured. For example, if the researcher decides to run only 50 training epochs for a benchmark and then decides to take the highest validation accuracy in that range, then the reported validation accuracy and the epoch at which it was achieved will be as shown in FIG. 1-1. If the researcher decides to run 100 training epochs and takes the highest validation accuracy in that range, then the reported validation accuracy and the epoch at which it was achieved will as shown in FIG. 1-2. If the researcher decides to run 150 training epochs and takes the highest validation range, then the reported validation accuracy and the epoch at which it was achieved will be as shown in FIG. 1-3. Thus the prior art's researcher degrees of freedom permits the researcher to influence two primary training performance metrics: validation accuracy and the number of epochs required to attain it.

Third, the prior art benchmarks such as those in paragraph often report just a single number, often some form of accuracy. An artificial neural network is a multi-variate construct with ranges of performance for multiple metrics. Two performance metrics that are typically of interest are the accuracy and efficiency of an artificial neural network. There is another operational metric of artificial neural networks that is of interest but is generally not reported by the prior art, that is the complexity of optimizing its hyper-parameters to obtain the desired accuracy and/or efficiency.

### B. Solution to the Problem

This invention is a new process created from established statistical methods and machine-learning processes. This Invention addresses the problems identified in paragraphs [0041], [0042], [0043], and [0044] that call into question the statistical validity of benchmark comparisons of performance metrics. This invention recognizes that artificial neural networks may have inherent variability due to their design, the equipment and software on which they are trained, and their interaction with different data. Specifically, the same artificial neural network, trained on the same data, may produce different distributions of benchmark performance metrics for different settings of the same hyper-parameters.

This invention is an essay that reduces the researcher degrees of freedom in the benchmark process by using an objectively determined over-training epoch as the measurement point for benchmark metrics.

This invention further reduces the researcher degrees of freedom in benchmark comparisons by using Bayesian highest posterior density intervals of performance metrics for comparisons of reasonably expected performance estimates of the artificial neural network at different hyper-parameter settings.

This invention tests the distributions of an artificial neural network's performance metrics at different hyper-parameter settings for normality in a factorial experiment framework.

This invention uses several univariate normality tests to flag performance distributions as non-normal.

This invention uses factorial experiment analysis to benchmark an artificial neural network's optimization complexity.

### C. Advantageous Effects of the invention

This invention may be used with any number of K hyper-parameter settings.

This invention is applicable to any number of B performance metrics relevant to a particular artificial neural network.

This invention's reduction in researcher degrees of freedom reduces the potential to influence benchmark results.

This invention provides for a concise visualization of benchmarks for comparison of an artificial neural network's reasonably expected performance at different hyper-parameter settings with the same and different data.

This invention provides the means to compare the reasonably expected performance of different artificial neural networks using the same data.

This invention yields reference documentation that can save users unfamiliar with an artificial neural network the time and computing expense to obtain the optimal hyper-parameter settings for artificial neural networks essayed with similar data.

This invention provides a measure of the hyper-parameter optimization complexity of the artificial neural network.

This invention is computing environment agnostic.

### BRIEF DESCRIPTION OF THE DRAWINGS

Sheet 1 of 6 accompanies this specification containing:

FIG. 1: Example of the prior art.

FIG. 2: Example of the objectively identified over-training epoch: the objectively identified minimum validation loss epoch and associated validation accuracy as benchmark metrics (B=2).

FIG. 3: A blow-up of the circled section in FIG. 2.

Sheet 2 of 6 accompanies this specification containing:

FIG. 4: Example hyper-parameter setting combinations and a center-point for a 2-level factorial experiment with K=3 hyper-parameters, and their abbreviations.

FIG. 5: Example hyper-parameter level settings for 2-level factorial experiment and one center-point for K=3 hyper-parameters.

Sheet 3 of 6 accompanies this specification containing:

FIG. 6: Example system parameter settings for the Pytorch computing environment.

FIG. 7: Example system-seed settings for the Python/Pytorch computing system.

FIG. 8: Example hyper-parameter level setting combinations vs training-run sample-seed assignment for K=4 hyper-parameters and two-level factorial experiment and one center-point.

Sheet 4 of 6 accompanies this specification containing:

FIG. 9: Benchmark metric Bayesian highest posterior density interval comparison chart for one artificial neural network with representative data for B=2 benchmark metrics: minimum validation loss epoch and associated validation accuracy.

Sheet 5 of 6 accompanies this specification containing:

FIG. 10: Benchmark hyper-parameter settings table with representative data for K=4 hyper-parameters.

FIG. 11: Benchmark effect and interaction coefficient table with representative data for K=4 hyper-parameters and B=2 benchmark metrics: minimum validation loss epoch and associated validation accuracy.

Sheet 6 of 6 accompanies this specification containing:

FIG. 12: Benchmark metric Bayesian highest posterior density interval chart for comparison of different artificial neural networks with representative data for B=2 benchmark metrics: minimum validation loss epoch and associated validation accuracy.

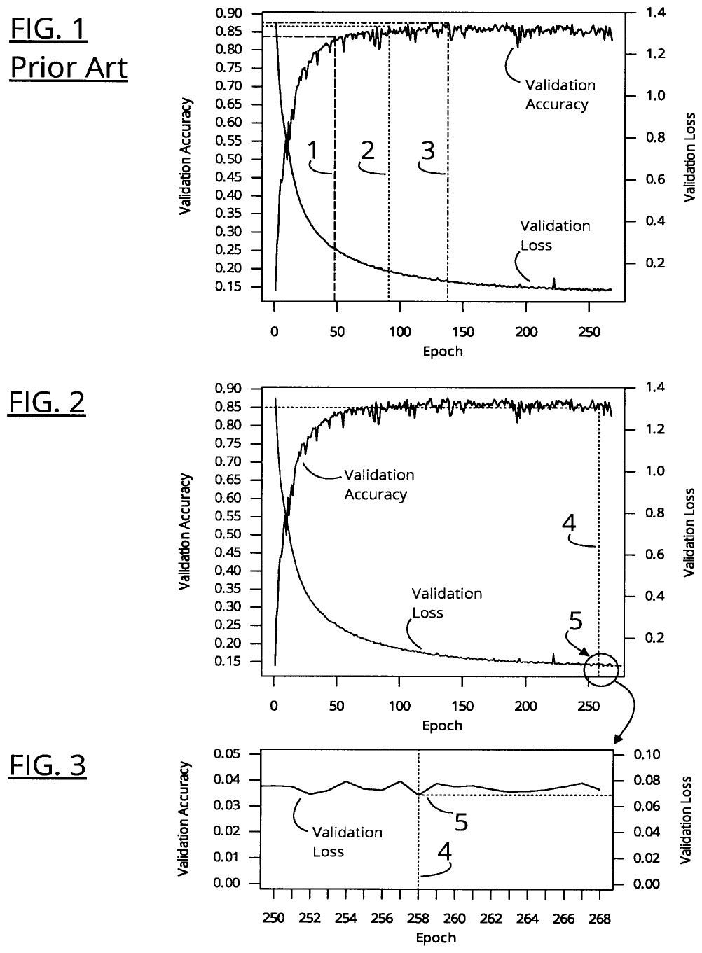

### DETAILED DESCRIPTION OF THE INVENTION

An artificial neural network has hyper-parameters that are variable settings used to control its training process. The effects and interactions of K number of these hyper-parameters on the performance of an artificial neural network are of interest.

An artificial neural network benchmark has B number of benchmark metrics of interest.

This invention uses a factorial experiment framework to estimate the effects and interactions of K number of hyper-parameter settings on benchmark metric distributions, and creates benchmarks that can compare reasonably expected B number of benchmark metrics, regardless of their distributions, of different artificial neural networks, and provides a concise visual comparison. This invention tests the benchmark metric distributions for normality.

### D. Overview

An overview of the process for this invention is:
1. Identify the artificial neural network and training dataset to be benchmarked.
2. Establish the objective criteria to identify the over-training epoch.
3. Identify the benchmark metrics. There are B number of benchmark metrics including the over-training epoch.
4. Identify the hyper-parameters that will be varied. There are K number of hyper-parameters to be tested.
5. Design the factorial experiment. A two-level plus one midpoint factorial experiment will have 2^{K}+1 hyper-parameter level setting combinations.
6. Determine the hyper-parameter level setting spread that:
   a. minimizes training instability, and
   b. captures an observable difference in artificial neural network performance without causing training instability, and
   c. is within the capacity of the computing environment.
7. Determine the number of training-runs (N) that will be made at each hyper-parameter setting combination, generally N>=30.
8. Obtain the sample-seed list of N pseudo-random numbers, one pseudo-random number for each of N training-runs.
9. Perform the benchmark tests using the training dataset. For each of the factorial experiment hyper-parameter level setting combinations make N training-runs:
   a. Enable the computing system randomization settings, unless it/they are being tested as a hyper-parameter(s).
   b. Enable data-shuffling, unless a particular data-loading sequence is being employed, or being tested as a hyper-parameter, or data-shuffling is being tested as a hyper-parameter.
   c. Initialize the computing environment seeded settings to the corresponding sample-seed of the sample-seed list of step 8.
   d. Each training-run proceeds until the over-training epoch of step 2 is reached.
   e. The benchmark metrics at the over-training epoch are recorded. There will be B benchmark metric sets of N data points for each of the factorial experiment hyper-parameter level setting combinations.
10. Analyze the benchmark metric distributions. For each set of N data points in step 9e:
   a. Use univariate normality tests to determine if the distribution is normal.
   b. Calculate the kernel density.
   c. Calculate the Bayesian highest posterior density interval (non-contiguous) from the kernel density.
11. Analyze the factorial experiment to estimate hyper-parameter effects and interactions for each benchmark metric.
   a. Scale and center the hyper-parameter level setting values.
   b. Perform regression analysis for the scaled and centered effects and interactions on each of the B benchmark metrics.
12. Create a concise visual display of the essay.

### E. Objective Determination of the Over-Training Epoch as the Benchmark Measurement Point

An objective determination of the over-training epoch of paragraph [0023] is required. An objectively defined over-training epoch is itself one of the B number of benchmark metrics. The remaining benchmark metrics are measured at the objectively determined over-training epoch for N training-runs at each of the hyper-parameter level setting combinations of paragraph [0071].

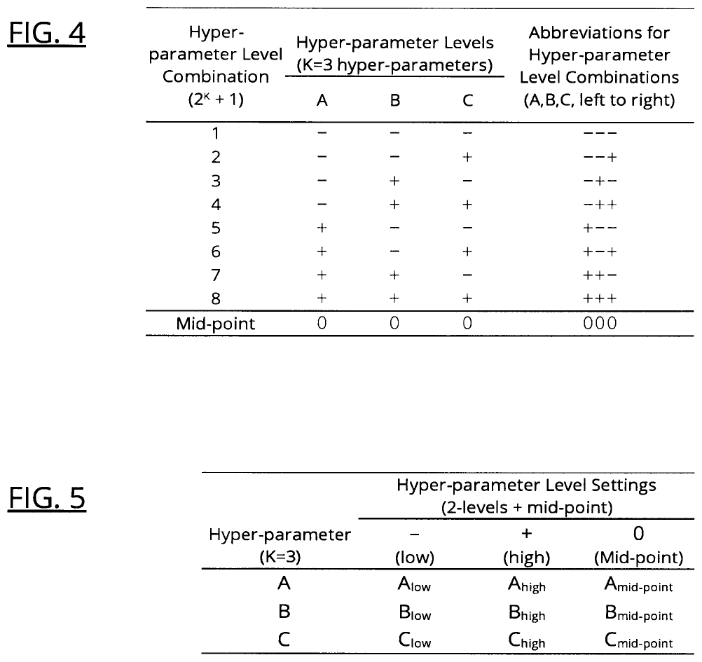

A basic artificial neural network that identifies a single object in an image may have B=2 benchmark metrics: validation accuracy and the minimum validation loss epoch as the over-training epoch. An objective determination of the minimum validation loss epoch during training eliminates the researcher degrees of freedom problem in paragraph [0043]. Different artificial neural networks will approach the minimum validation loss epoch differently, some with more or less oscillatory behavior. In the absence of specific performance knowledge of an artificial neural network design for determination of the over-training epoch, an objective determination method may be used such as described in paragraph [0022]. An example of this is shown in FIG. 3-4 where the minimum validation loss epoch is 258, which was the first occurrence of a low validation loss immediately followed by ten epochs without a lower validation loss, as shown in FIG. 3-5. The validation accuracy at the minimum validation loss epoch, shown in FIG. 2-4, and the minimum validation loss epoch itself are reported as the benchmark metrics, as shown in

FIG. 2-5, regardless of how many epochs were computed to attain it. The benchmarks are the distributions of the B=2 performance metrics of the N training-runs at each of the hyper-parameter setting combinations of paragraph [0071], at an objective determination of the minimum validation loss epoch.

### F. Combined Factorial Experiment Design and Distribution Normality Test

A 2-level factorial experiment for the hyper-parameter settings is designed, composed of the 2^{K} possible combinations of high(+), low(−) level pairs for each hyper-parameter setting. One additional combination of the mid-points(0) for the hyper-parameter settings is also created for a total of 2^{K}+1 hyper-parameter level setting combinations. Factorial experiments are described in IDS non-patent literature reference #1 (1978, G. E. Box, W. H. Hunter, S. Hunter). A generic example for K=3 hyper-parameters is shown in FIG. 4.

The high (+), low (−) and midpoint (0) hyper-parameter level setting values must be applicable to the particular artificial neural network being essayed. A generic example with K=3 hyper-parameters is shown in FIG. 5. The actual numeric values are empirically determined for the particular artificial neural network to determine each hyper-parameter's level setting spread that can capture its effects, that keeps the training is stable, and is within the capacity of the computing equipment.

Performance Metric Data. To be able to test the distributions for normality and to be able to obtain a reasonable estimate of the kernel density of the distribution, at least thirty training-runs (N>=30) are made at each hyper-parameter setting combination of the experiment. Thus the benchmark data for the essay, per paragraph [0071], will comprise (2^{K}+1) sets of N data-points for each of B benchmark metrics.

### G. Structured Randomization of the Factorial Experiment Training Runs

Data Shuffling and Data Loading Sequence. Unless data-shuffling itself is being tested as a hyper-parameter, or a specific data-loading sequence is being used and/or tested as a hyper-parameter, the best mode for data-shuffling is to have it enabled. Each computing environment will have its own settings to enable or disable data-shuffling.

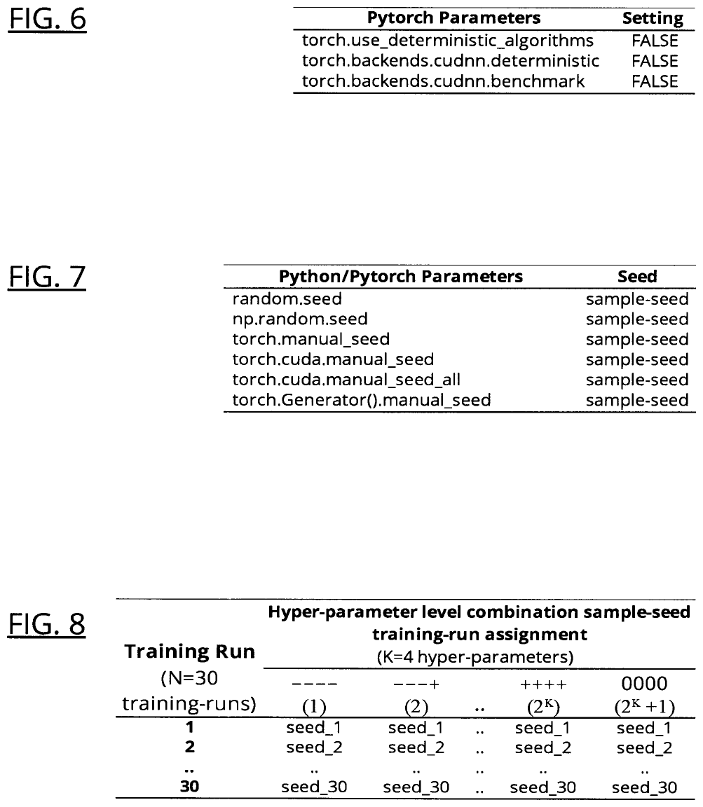

Deterministic and Non-Deterministic Computing Environment Algorithms. Artificial neural networks are generally created in specialized computing environments such as Pytorch/Torchvision, Tensorflow, etc., with new computing environments being developed. These computing environments are comprised of the hardware, operating system and programming language(s) in which they are written. These computing environments may use non-deterministic internal algorithms in their execution, and may have settings to enable or disable their use. Each of these computing environments has its own settings to configure the randomization of its internal operations that are comprised of operational directives to itself and the hardware upon which it runs. Because the commands are computing environment specific, instead of pseudo-code, the actual code used in just one computing environment is demonstrated. Different computing environments will have similar functional settings. Unless these settings themselves are being tested as hyper-parameters, the best mode for these settings are those that will be used when training an artificial neural network for its intended purpose. This will usually be to permit randomization unless a particular setting causes instability for the artificial neural network. An example of these settings for the open source Pytorch computing environment is shown in FIG. 6.

Structured Seed Randomization. The randomization for the experiment is achieved by using a fixed set of N pseudo-random numbers as initialization seeds, one for each of N training-runs. This is done by first setting a system seed, then making N program calls for a pseudo-random number, to obtain the sample-seeds (seed_1 through seed_N) for the N training-runs. An example of obtaining the pseudo-random numbers in the general purpose Python programming language is given in IDS non-patent literature reference #8 that uses a U.S. postal-code for the initial system seed to obtain a list of N pseudo-random numbers.

Different computing environments will have different random seed settings for many of their processes. The particular code or commands may vary for each computation environment. Regardless of the computing environment, all of the random seed settings should be set to the sample-seed of paragraph for each training-run. An example of these environment settings are shown for the Python/Pytorch computing environment in FIG. 7.

N training-runs are made for each hyper-parameter level setting combination in paragraph [0071]. At the beginning of each of the N training-runs for each each hyper-parameter level setting combination, the computing environment random seed settings in paragraph [0077] are set to the corresponding sample_seed in paragraph [0076]. An example of the sample-seed training-run assignment for K=4 hyper-parameter settings and a 2-level factorial with a center-point experiment with N=30 training-runs, is shown in FIG. 8.

### H. Multiple Univariate Normality Tests

The distributions of the training performance metrics in paragraph [0073] are flagged as being non-normal if any of the following statistical univariate normal distribution tests for the N data-points yield a p-value<0.05: Anderson-Darling, Cramer-von Mises, Jarque-Bera, Kolmogorov-Smirnov, Pearson Chisq, Shapiro-Francia or Shapiro-Wilk.

### I. Bayesian Highest Posterior Density Intervals as Benchmarks to Compare Benchmark Metrics

Kernel density is estimated for each set of N data-points for each hyper-parameter level setting combination for each of B benchmark metrics in paragraph [0073].

Bayesian highest posterior density intervals that are non-contiguous are computed from the kernel density estimates in paragraph [0080].

The estimation of the kernel density from the N data-points of paragraph [0080] and the Bayesian highest posterior intervals of paragraph [0081] can be computed using any number of open-source or commercial statistical programs. An example using the open source R-cran program to do so is shown in IDS non-patent literature reference #9.

### J. Factorial Experiment Analysis of Benchmark Optimization Complexity

The effects and interactions of the hyper-parameters are estimated by using established statistical methods for factorial experiment analysis, including scaling and centering the hyper-parameter level setting values, and their use as regressors for linear regressions for each of B benchmark metrics. Any number of open-source or commercial statistical programs can be used for these calculations. An example of the open-source R-cran code to do so is shown in IDS non-patent literature reference #10.

K. A Concise Display of Essay Results

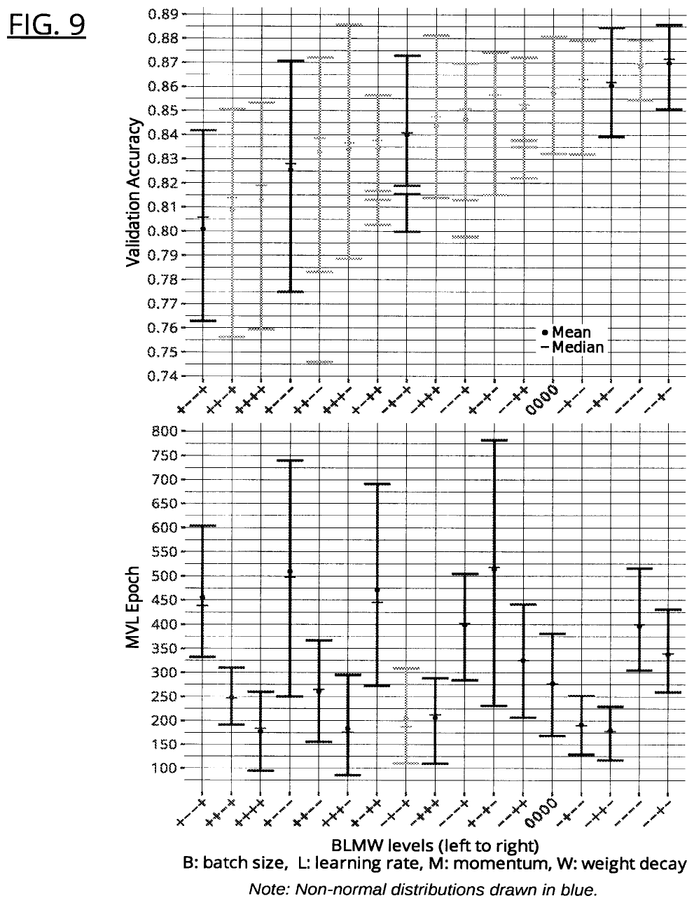

Bayesian Highest Posterior Density Interval Graph. Given space in a particular medium, the best mode for displaying the Bayesian highest posterior density interval data is graphical. The Bayesian highest posterior density intervals for each of the training performance metrics are graphed for each hyper-parameter level setting combination in paragraph [0071]. This description is for graphs with common categorical horizontal axes being the hyper-parameter level setting combinations. The distribution mean of the benchmark metric of most interest is used to determine the categorical horizontal axis sort order of the graphs. The series of graphs for the visual display is applicable to any B number of benchmark metrics. This description uses B=2 benchmark metrics: the minimum validation loss epoch as the over-training epoch, and the associated validation accuracy, and describes a vertically oriented graph. The vertical axes of the graphs have scales appropriate for the benchmark metrics: the validation accuracy Bayesian highest posterior density interval graph has a decimal or percent vertical axis, and the minimum validation loss epoch Bayesian highest posterior density interval graph has an integer vertical axis of epoch number. Both graphs use the same categorical horizontal axes, that being one point for each Bayesian highest posterior density interval's hyper-parameter setting abbreviation consisting of the high(+), low(−) and midpoint(0) abbreviations such as “+−+−”. The Bayesian highest posterior density intervals are graphed as a vertical line drawn from the maximum and minimum values of the interval, with separate lines drawn for each non-contiguous interval. A horizontal line is drawn at the maximum and minimum of each Bayesian highest posterior density interval vertical line such that its horizontal length leaves a visual space between those of the intervals on either side. For each Bayesian highest posterior density interval a small circle is drawn on the vertical line for the distribution mean, and a horizontal line is drawn on the vertical line for the distribution median. The distribution median line is shorter than the Bayesian highest posterior density interval interval maximum and minimum lines. The circle indicating the mean and the horizontal line indicating the median are sized to be visible when overlapping. The filled circle indicating the mean is also sized to make it easy to visually read its value on the vertical axes. The Bayesian highest posterior density interval vertical and horizontal lines, distribution mean and median markers for non-normal distribution, per paragraph [0079], are drawn in a manner distinguishable from those of normal distributions, the best mode for which is a different color. The benchmark metric of most interest is used to determine the categorical horizontal axis sort order. Accuracy measures are generally the performance metric(s) of most interest and so its use to perform the sort is the best mode. In this description the accuracy metric is validation accuracy. The Bayesian highest posterior density intervals of both graphs are sorted from left-to-right by the increasing mean of the validation accuracy distributions for each hyper-parameter level setting. The chart should have a legend that identifies the hyper-parameters and setting levels. An example chart with representative data for K=3 hyper-parameters and B=2 performance metrics is shown in FIG. 9. Additional benchmark metrics as described in paragraph [0006] would each have additional Bayesian highest posterior density interval graphs with the same common categorical axes. The best mode would be to have the graphs next to each other with common categorical axes aligned, space and medium permitting.

Bayesian Highest Posterior Density Interval Table. The best mode for displaying the Bayesian highest posterior density interval data in a space limited medium is tabular. Table(s) of the graph data of paragraph [0084]. This description is for a table with a vertical orientation. A table is made comprising: a column listing each hyper-parameter level setting abbreviation, and columns for the mean, median, maximum, and minimum values for each benchmark metric distribution at each hyper-parameter level setting combination. The rows for the hyper-parameter level setting combination distributions that are non-normal, per paragraph [0079], are printed in a manner distinguishable from those of normal distributions. The table is sorted by the mean value of the benchmark metric of interest.

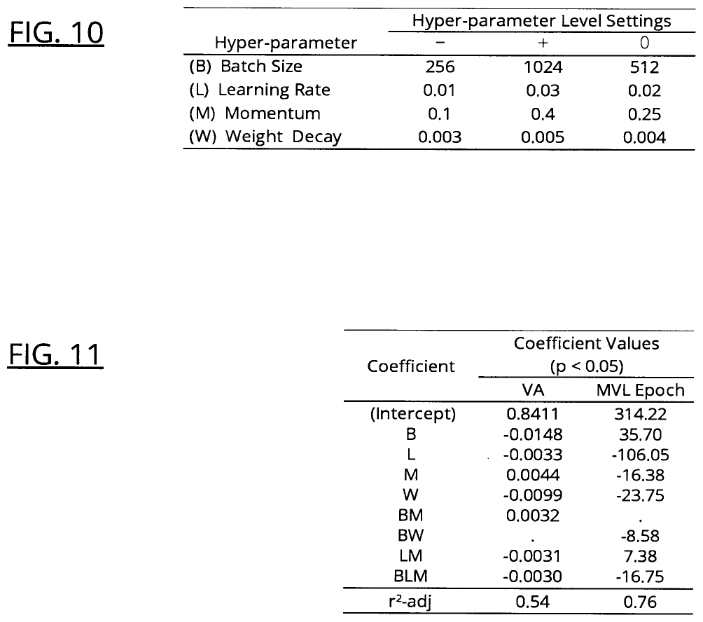

Hyper-Parameter Level Setting Table. This description is for a table with a vertical orientation. A table is made comprising four columns. One column that lists the hyper-parameters that were set during the essay, along with any abbreviation used to identify the hyper-parameter. One column that displays the low(−) setting values of the hyper-parameters during the essay, one column that displays the high(+) setting values of the hyper-parameters during the essay, and one column that displays the midpoint(0) hyper-parameter settings used during the essay. An example with representative data for K=4 hyper-parameters is shown in FIG. 10.

Hyper-Parameter Effect and Interaction Table. This description is for a vertically oriented table. A table is made with a column that identifies the effects and interactions of

the hyper-parameters effects and interactions from paragraph [0083], and adjacent columns for each of the B benchmark metrics containing their statistically significant regression coefficients, or a non-numeric placeholder, the best mode for which is a period or dot and omitting the rows of effects and interactions which no statistically significant coefficients for any of the benchmark metrics. The table should contain a row for the corresponding adjusted r-square regression estimates with the best mode being the bottom or top row. An example of the general form for this table for K=4 hyper-parameters using representative data for B=2 performance metrics with minimum validation loss epoch as the over-training epoch and validation accuracy, is shown in FIG. 11.

Benchmark comparisons of an artificial neural network trained with same training dataset at different hyper-parameter level combinations. The best mode of display given sufficient space in a medium for a concise view of this essay is the combination of the elements of paragraph [0084], paragraph [0086], and paragraph [0087]. The best mode of display given limited space in a medium is the combination of elements of paragraph [0085], paragraph [0086], and paragraph [0087].

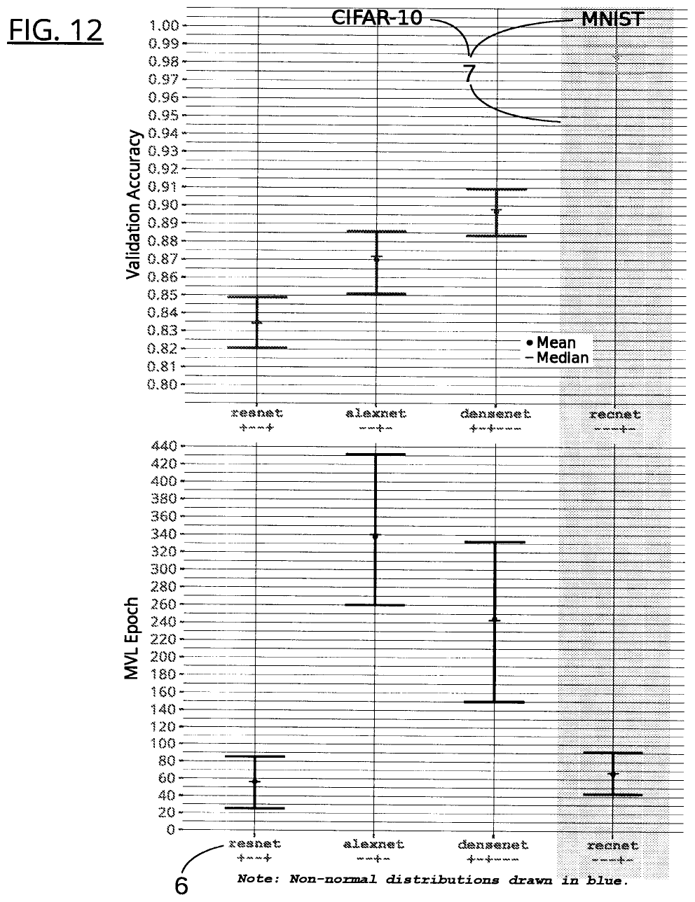

Benchmark comparisons of different artificial neural networks trained with the same training dataset can be made by performing this essay, outlined in paragraph [0068], for each artificial neural network to be compared using the same training dataset. Then from each essay, the Bayesian highest posterior density intervals with the highest mean benchmark metric of interest are selected. The best mode for display given space in a medium is that these Bayesian highest posterior density intervals are graphed in the same manner as described paragraph [0084] with the addition of the identification of each artificial neural network to the hyper-parameter settings on the categorical axis. An example of this is shown in FIG. 12-6.

The best mode of display given limited space in a medium is a table of the graph data described in paragraph [0085], with an additional column or indicator of the artificial neural network to which each row refers.

Benchmark comparisons of the same artificial neural network trained using different training datasets can be made by performing this essay, outlined in paragraph [0068], for each training dataset to be compared. Then from each essay, the Bayesian highest posterior density intervals with the highest mean benchmark metric of interest are selected. The best mode for display given space in a medium is graphical. These Bayesian highest posterior density intervals are graphed in the same manner as described paragraph with the addition of a training dataset identifier for the Bayesian highest posterior density interval(s). An example of this is shown in FIG. 12-7.

The best mode of display given limited space in a medium is a tabular. A table of the graph data described in paragraph is created [0085] with an additional column or indicator of the artificial neural network to which each row refers.

1. A benchmark essay of an artificial neural network's performance metrics trained at different hyper-parameter settings using the same training dataset comprising
objective criteria to determine the over-training epoch to be used as the measurement point of the B number of benchmark metrics of interest for each training-run in a combined factorial experiment framework and normal distribution test to determine the effects on an artificial neural network of K number of hyper-parameters on the B number of benchmark metric distributions;
in which each of the hyper-parameter level setting values are selected for the artificial neural network and training dataset being essayed to have sufficient hyper-parameter setting range between high and low factorial experiment level values to capture its effects, while minimizing training instability, and be within the computing environment's capability;
a structured randomization of the factorial experiment's N training-runs where the same set of N pseudo-random numbers are used as seeds to initialize the computing system seeded values for each of N training-runs at each hyper-parameter level setting combination of the factorial experiment, such that each training-run is assigned a different pseudo-random number from the same set;
multiple statistical univariate normal distribution tests are used to flag non-normal benchmark metric distributions for each set of N benchmark metric data points comprising: Anderson-Darling, Cramer-von Mises, Jarque-Bera, Kolmogorov-Smirnov, Pearson Chisq, Shapiro-Francia and Shapiro-Wilk univariate normality tests;
linear regression analysis of the factorial experiment data used to estimate statistically significant hyper-parameter effects and interactions on benchmark metrics, comprising the scaled and centered hyper-parameter level setting values of the factorial experiment used as regressors in a linear regression for each of the B benchmark metrics;
statistical kernel density estimates calculated for each of the B benchmark metric sets of N data-points for each hyper-parameter level setting combination of the factorial experiment design, each used to calculate Bayesian highest posterior density intervals for benchmark comparisons.

2. A table comprising the hyper-parameters, hyper-parameter abbreviations, the factorial experiment level settings and their values used in claim 1.

3. A table comprising the list of hyper-parameter effects and interactions in claim 1 with adjacent listings of the statistically significant coefficients for each of the B performance metrics of interest.

4. A graph of the data of claim 1 comprising graphs of the Bayesian highest posterior density intervals of each of the B benchmark metrics for each of the hyper-parameter level setting combinations of the factorial experiment design, with markers for the mean and median of each distribution, with the same categorical axes of factorial experiment hyper-parameter level setting combinations, sorted by the mean benchmark metric of interest, with the Bayesian highest posterior density intervals from non-normal distributions drawn in a manner distinguishable from the others.

5. A table comprised of the data graphed in claim 4.

6. A comparison of the benchmark metrics of different artificial neural networks trained using the same training dataset comprising
a set of benchmark essays of claim 1 performed for each artificial neural network using the same training dataset;
a graph of the Bayesian highest posterior density intervals of the benchmark metrics of interest having the highest mean benchmark metric from each essay in the set, with markers for the mean and median of each distribution, with the same categorical axes of factorial experiment hyper-parameter level setting combinations as well as identification of the particular artificial neural network, sorted by the mean benchmark metric of interest, with the Bayesian highest posterior density intervals from non-normal distributions drawn in a manner distinguishable from the others;
a table of the of the data used to make the preceding graph.

7. A comparison of the benchmark metrics of the same artificial neural network trained using different training datasets comprising
a set of benchmark essays of claim 1 performed for the same artificial neural network for each different training dataset to be compared;
a graph of the Bayesian highest posterior density intervals of the benchmark metrics of interest having the highest mean benchmark metric from each essay in the set, with markers for the mean and median of each distribution, with the same categorical axes of factorial experiment hyper-parameter level setting combinations as well as identification of the training datasets used, sorted by the mean benchmark metric of interest, with the Bayesian highest posterior density intervals from non-normal distributions drawn in a manner distinguishable from the others;
a table of the of the data used to make the preceding graph.
